(19) United States
(12) Patent Application Publication
(10) Pub. No.: US 2008/0307839 A1
(43) Pub. Date: Dec. 18, 2008

(54) Lock having an indicatory lock core

(76) Inventor: Chun Te Yu, Fusing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/213,031

(22) Filed: Jun. 13, 2008

(30) Foreign Application Priority Data
Jun. 14, 2007 (TW) 096121600

(51) Int. Cl. E05B 41/00

(52) U.S. Cl. 70/330

(57) ABSTRACT

This invention relates to a lock, which includes a housing and an indicative lock core. The indicative lock core is operable by a key to move to an indicative position and be stuck in the indicative position. The indicative lock core can move back to its original position only through a restore mechanism. When the key-operated lock core is in the indicative position, the key-operated lock core is partly situated outside the housing and is easily noticed.

### BACKGROUND OF INVENTION

1. Field of Invention

This invention relates to a lock, and more particularly to a lock including an indicative lock core adapted both to lock/unlock the lock and to indicate whether the lock has been unlocked.

2. Related Prior Art

U.S. Pat. No. 6,877,345 and U.S. Pat. Pub. No.: 2005/0262902A1 each shows a lock including an indicator therein. The indicator is capable of being driven by a key-operated lock core of the lock to move to an indicative position, whereby it indicates to a user whether the key-operated lock core of the lock has been operated. However, the indicator occupies some of the space inside the lock and is also correlated with an increase in structural complexity.

### SUMMARY OF INVENTION

This invention relates to a lock including a housing and an indicative lock core. The indicative lock core is configured to be activated by a key in order to lock/unlock the lock and to indicate whether the indicative lock core of the lock has been operated as to unlock the lock.

The indicative lock core includes a spindle. The spindle defines a keyhole for receiving the key.

Preferably, the indicative lock core is configured in a way that the spindle moves to an indicative position when the key is taken out from the keyhole.

Preferably, the indicative lock core is configured in a way that the spindle moves to the indicative position when the key is inserted into the keyhole.

Preferably, the indicative lock core is configured in a way that the spindle moves to the indicative position when the key drives the spindle to rotate.

In any case, when the spindle is in the indicative position, the spindle is partly situated outside the housing in order to demonstrate that the indicative lock core has been operated.

### BRIEF DESCRIPTION OF DRAWINGS

FIGS. 1-17 illustrate a first embodiment of the invention.

FIGS. 18-21 illustrate a second embodiment of the invention.

FIGS. 22-27 illustrate a third embodiment of the invention.

FIGS. 28-32 illustrate a fourth embodiment of the invention.

FIG. 33 illustrates a fifth embodiment of the invention.

FIG. 34 illustrates a sixth embodiment of the invention.

### DETAILED DESCRIPTION OF EMBODIMENTS

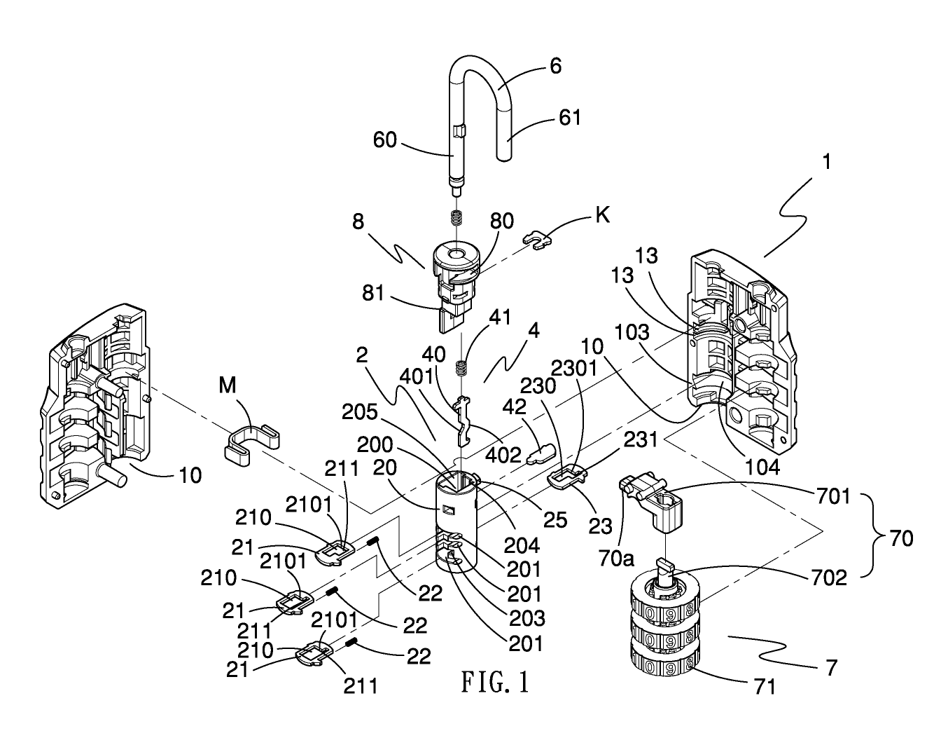

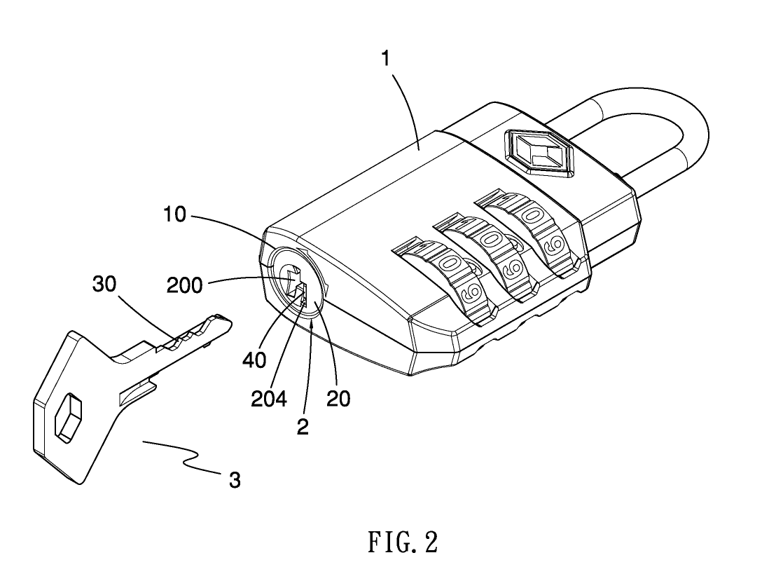

Referring now to FIGS. 1 and 2 of the drawings, a lock in accordance with a first embodiment of the invention includes a housing 1 and an indicative lock core 2. The housing 1 defines an opening 10 in a side. The indicative lock core 2 is disposed in the housing 1 and includes a spindle 20, a plurality of latch plates 21 and a plurality of springs 22.

The spindle 20 has a cylindrical shape and is normally received in the opening 10 of the housing 1. The spindle 20 defines a keyhole 200 therein and a plurality of latch slots 201 parallel to one another. The keyhole 200 is configured to receive teeth 30 of a key 3 which is mated with the indicative lock core 2. These latch slots 201 are vertically interconnected with the keyhole 200. These latch plates 21 together with the corresponding springs 22 are assembled in the latch slots 201 respectively. The springs 22 are biased by the latch plates 21 respectively in such a way that the latch plates 21 are normally partly situated outside the latch slots 201. Anyway, those latch plates 21 may bounce out of or draw back to the latch slots 201 as a result of the flexibility of the springs 22.

Each of the latch plates 21 defines a hole 210 therein. When each latch plate 21 is assembled in the respective latch slot 201, the holes 210 are in alignment/communication with the keyhole 200. Inner plateaus 2101 of the holes 210 of the latch plates 21 are located in different height levels, some higher, some lower, and no two ones are situated in the same level, and that depends on shape of the teeth 30 of the key 3.

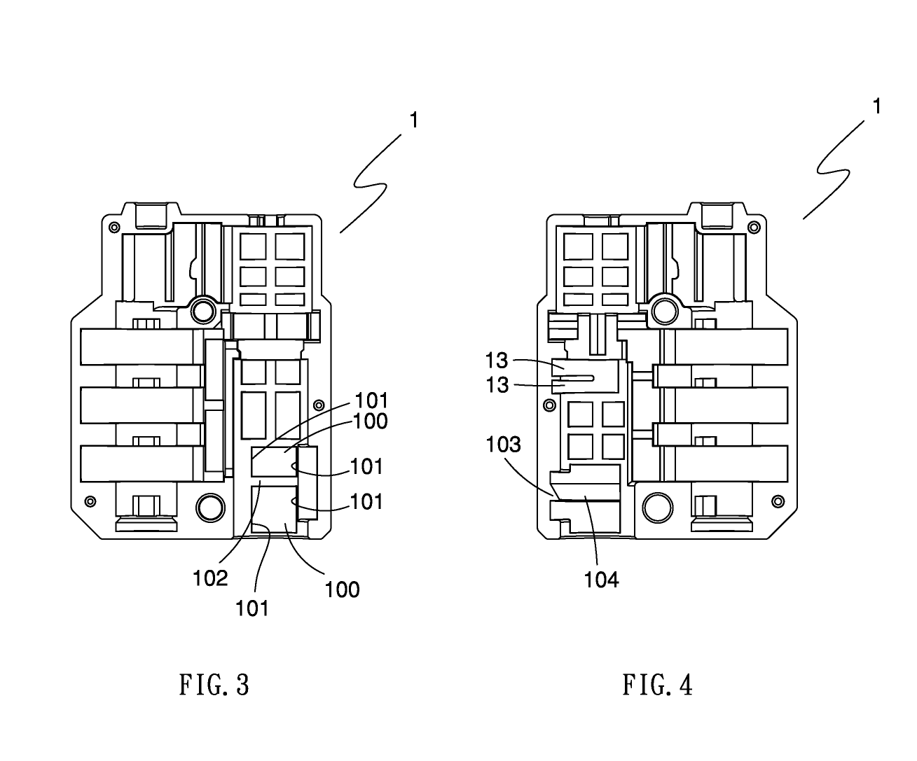

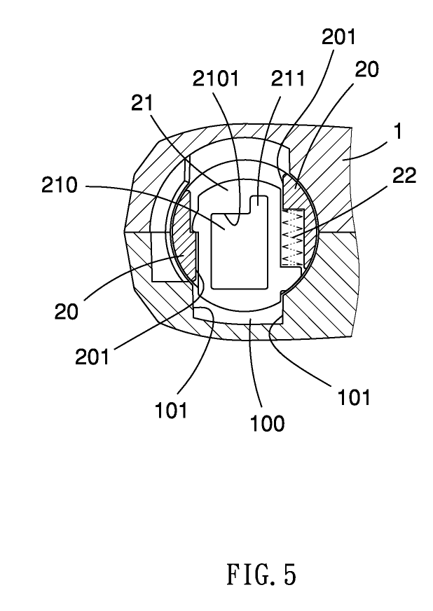

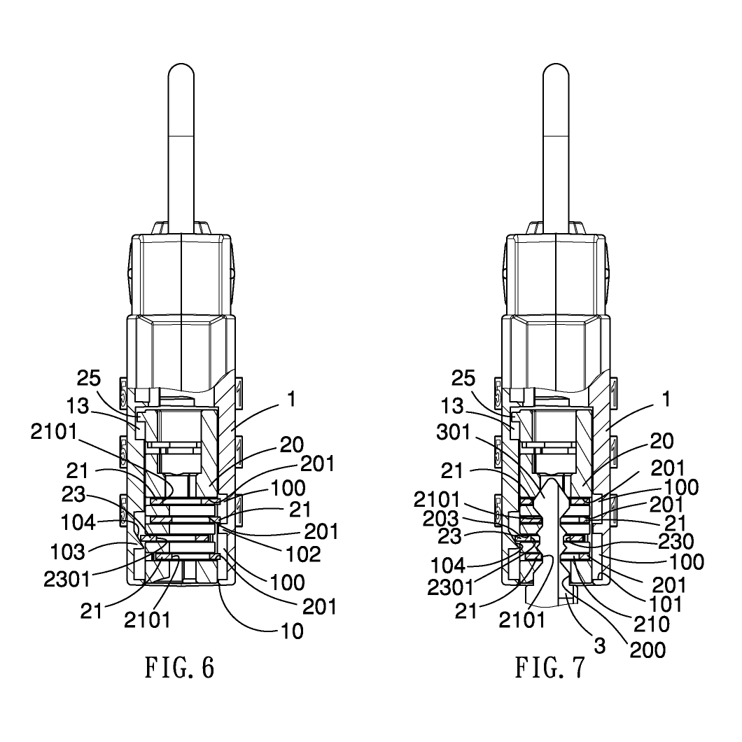

As shown in FIGS. 1 and 3, the housing 1 defines a room 100 corresponding to the latch plates 22 and has a ridge 102 dividing the room 100 into an upper section and a lower section. As shown in FIGS. 5 and 6, those portions of the latch plate 100 which are located outside latch slots 201 are normally received in the room 100 and are confined by opposed side walls 101 of the room 100 in such a way that the spindle 20 is not allowed to rotate. In addition, as shown in FIG. 6, since at least one latch plate 21 with its portion located outside the latch slot 201 is blocked by the ridge 102, the spindle 20 is not allowed to move toward the opening 10 either.

As shown in FIG. 1, the indicative lock core 2 further includes a blocking plate 23. The spindle 20 further defines a blocking slot 203 for receiving the blocking plate 23. The blocking slot 203 is in parallel with those latch slots 201 and vertically interconnected with the keyhole 200. The blocking plate 23 defines a hole 230. When the blocking plate 23 is assembled in the blocking slot 230, the hole 230 is in alignment/communication with the keyhole 200. An inner plateau 2301 of the hole 230 and the inner plateaus 2101 of the latch plate 21 are located on the same side.

As shown in FIGS. 1 and 4, the housing 1 has a rib 103 corresponding to the blocking plate 23. The rib 03 has an incline 104.

As shown in FIG. 7, when the key 3 is inserted into the keyhole 200 and passes through all the holes 210 of the latch plates 21 and the hole 230 of the blocking plate 23, the latch plates 21 retract into the latch slots 201 from the room 100 of the housing 1 as a result of the inner plateaus 2101 of the latch plates 21 being pressed by the teeth 30 of the key 30. That is, the latch plates 21 are no more confined by the two opposite side walls 101 of the room 100. At this time, the spindle 20 is allowed to be rotated by the key 3.

As stated above, when the key 3 is inserted into the keyhole 200, the plateau 2301 of the blocking plate 23 is pressed by the teeth 30 as well so that the blocking plate 23 is partly situated outside the blocking slot 203. In this embodiment, the teeth 30 have a highest awl-shaped protrusion 301. The plateau 2301 of the blocking plate 23 is pressed by the highest awl-shaped protrusion 301 so that the blocking plate 23 is pushed and partly situated outside the blocking slot 203. When the spindle 20 is rotated to its original position via the key 3, the key 3 is allowed to be removed from the keyhole 200 of the spindle 20 so as to have each latch plates 21 be restored to its original state where each latch plates 21 is partly received in the room 100. At this time, the blocking plate 23 remains partly situated outside the blocking slot 203 and abutting against the incline 104 of the housing 1.

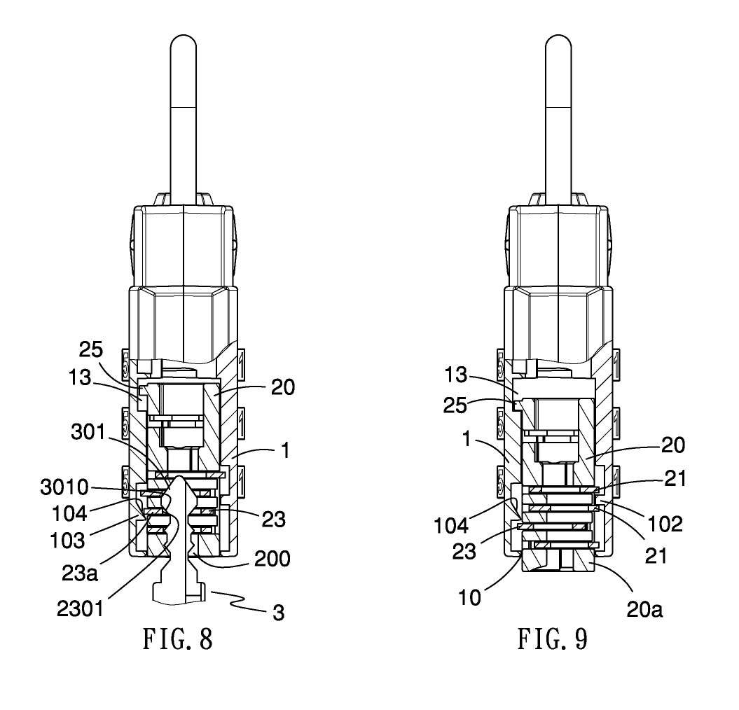

As shown in FIG. 8, while the key 3 is drawn out of the keyhole 200 of the spindle 20, a lower portion of the plateaus 2301 of the blocking plate 23 is first slightly stuck in between an incline 3010 of the highest awl-shaped protrusion 301 and the incline 104 so that the key 3 can grab and drag the spindle 20 to move together. When the lower portion of the blocking plate 23 moves with the spindle 20 and crosses the incline 104, the key 3 pushes the blocking plate 23 away via its incline 3010 so that the spindle 20 is no more movable with the key 3 and remains in an indicative position. Then, since the key 3 is no more kept by blocking plate 23, the key 3 may continue to completely move out of the keyhole 200 by itself.

As shown in FIG. 9, when the spindle 20 remains in the indicative position, a portion 20a of the spindle 20 is situated outside the opening 10 and exposed outside the housing 1. Because the ridge 102 of the housing 1 exactly gets stuck in between two of the latch plate 21, the spindle 20 is stuck and unable to be pushed back to its original position or drawn out further. The portion 20a of the spindle 20 situated outside the housing 1 indicates that the spindle 20 has been operated by the key 3. To attract one's attention, the portion 20a of the spindle 20 shall be painted with a color different from the color of the housing 1 at least. Preferably, there is a contrast between the color of the whole spindle 20 and the color of the housing 1.

As shown in FIGS. 1 and 2, the lock further includes a restoring device 4 configured to push the portion 20a of the spindle 20 back into the housing 1. To install the restoring device 4, the spindle 20 of the indicative lock core 2 further defines a restoring passage 204, each latch plate 21 defines a restoring hole 211, and the blocking plate 23 defines a restoring hole 213. The restoring passage 204 is parallel with the keyhole 200 and in communication with each other. When each latch plate 21 is assembled in the respective latch slot 201, the restoring holes 211 are exactly in alignment/communication with the restoring passage 204. When the blocking plate 23 is assembled in the blocking slot 203, the restoring hole 213 is exactly in alignment/communication with the restoring passage 204. The restoring device 4 includes a restoring plate 40, a spring 41 and a fixing plate 42. The restoring plate 40 has a cone recess 401 and an opposite cone protrusion 402 at the middle.

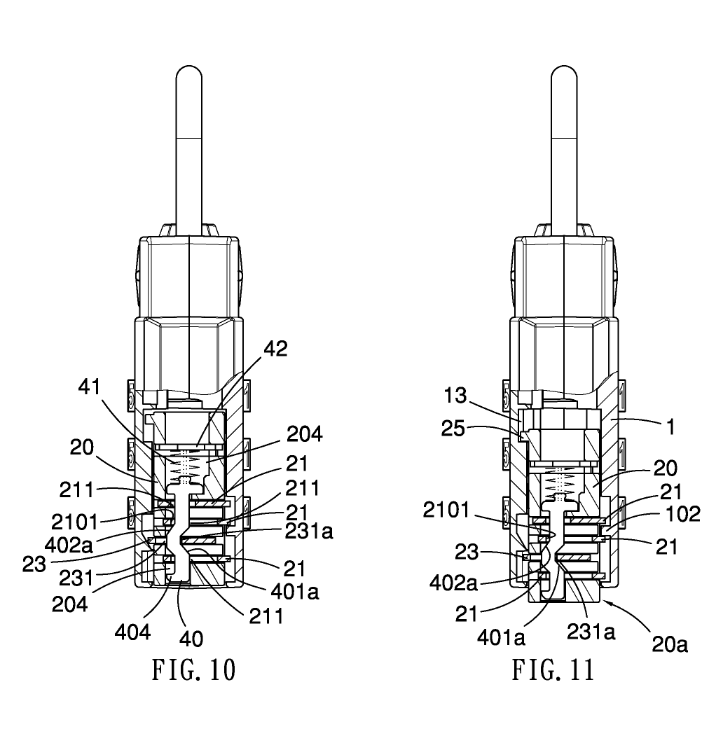

As shown in FIG. 10, the restoring plate 40 is assembled in the restoring passage 204 and passes through the restoring holes 211 of the latch plates 21 and the restoring hole 231 of the blocking plate 23. The fixing plate 42 is lodged in the spindle 20 and passes through the restoring passage 204. The spring 41 is biased between the restoring plate 40 and the fixing plate 42. In particular, the restoring hole 231 of the blocking plate 23 is exactly aligned with the middle section of the restoring plate 40. An edge 231a of the restoring hole 231 of the blocking plate 23 abuts against an incline 401a of the cone recess 401. One of the latch plates 21 has its plateau 2101 abutting against an incline 402a of the cone protrusion 402.

FIG. 11 illustrates that the spindle 20 is dragged out by the key 3 in order to expose the portion 20a and is stuck in the indicative position. At this time, as mentioned above, the ridge 102 of the housing 1 is stuck in between the two latch plates 21. However, a relationship among the restoring plate 40, the latch plates 21 and the blocking plate 23 remains the same.

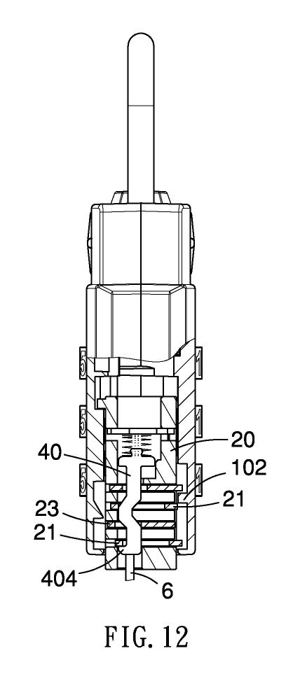

FIG. 12 illustrates that a tool 6, such as an elongated stem or a thin strip, is used to push the restoring plate 40 inward. At this time, the restoring plate 40 moves backward a bit so that one of the latch plates 21, which is originally blocked by the ridge 102, and the blocking plate 23 are both pressed by the restoring plate 40 to retract, and thereby the spindle 20 is in a state ready to be moved inward. Because a tail portion 404 of the restoring plate 40 presses one of the latch plates 21, the tool 6 can be pushed inward further so as to bring the spindle 20 to its original position, as shown in FIG. 10.

According to the above, the spindle 20 can be rotated by rotation of the key 30 so as to lock or unlock the lock. In particular, the spindle 20 can be dragged out and partly situated and exposed outside the housing 1 by drawing out the key 3 from the keyhole 200 of the spindle 20, and whereby the exposed spindle 20 indicates that the indicative lock core 2 has been operated or activated by the key.

As shown in FIG. 1, the lock is a padlock in nature. That is, the lock includes a shackle 6. The shackle 6 has a root section 60 and a free section 61. The root section 60 is disposed in the housing 1. The free section 61 extends from the housing 1 and disposed outside the housing 1.

In order to become a dual lock, the lock further includes a combination lock core 7 and a controlling unit 8. The combination lock core 7 includes a movable part 70 and a plurality of numeral wheels 71. When a correct combination on the numeral wheels is dialed, the movable part 70 is allowed to move axially. When a wrong combination on the numeral wheels is dialed, the movable part 70 is locked and is not allowed to move axially. In this embodiment, the movable part 70 is composed of an upright stem 702 and a lateral stem 701 joined to the upright stem 702 in order that the movable part 70 can reach to the controlling unit 8.

The controlling unit 8 is in the housing 1 and is able to rotate and move axially. The root section 60 of the shackle 6 is rotatably mounted on the controlling unit 8 via a U-shaped latch so that the shackle 6 can rotate toward or away from the housing 1. The controlling unit 8 includes a block 80 and a driving member 81. The driving member 81 is wedged in a notch 205 of the spindle 20 so that the driving member 81 can rotate with the spindle 20, and thereby the spindle 20 can be used to drive the driving member 81. An elastic plate M, as shown in the figure, is mounted around the controlling unit 8 for elastically securing the controlling unit 8 when controlling unit 8 rotates.

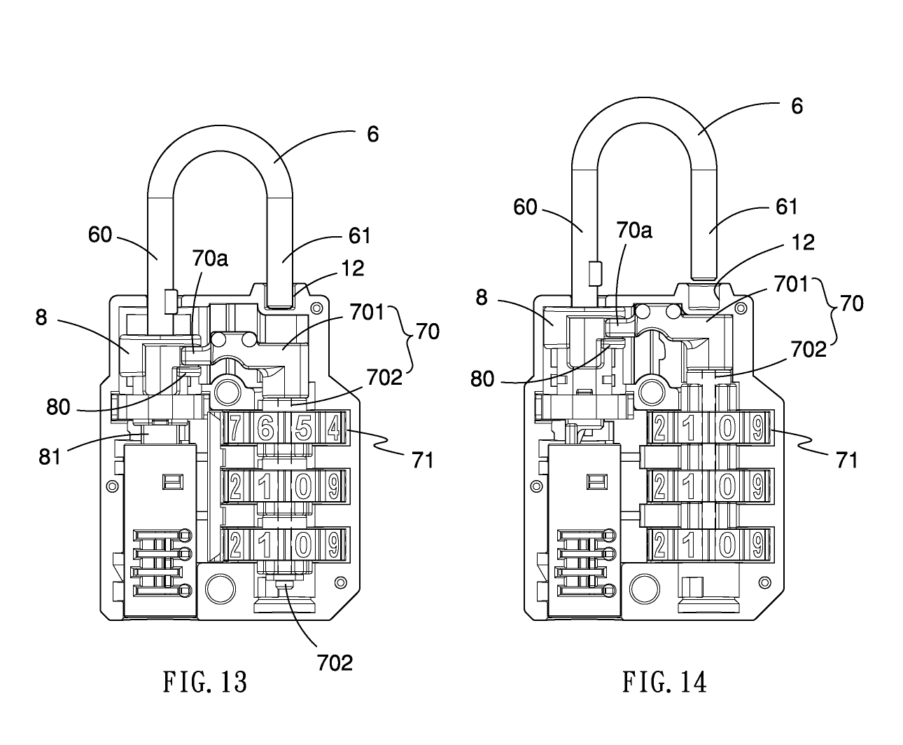

As shown in FIG. 13, the movable part 70 actually extends at one end 70a to the block 80 of the controlling unit 8. The movable part 70 is not allowed to move axially since the end 70a is obstructed by the block 80. At this time, the lock is in a locking state.

As shown in FIG. 14, when the correct combination on the numeral wheels 71 is set and the movable part 70 is allowed to move axially, the shackle 6 can be pulled away from the housing 1. At this time, because the block 80 obstructs the end 70a of the movable part 70, the controlling unit 8 and the movable part 70 are allowed to move axially with the shackle 6, and thereby the free section 61 of the shackle 6 can be released from a locking hole 12 of the housing 1 so as to have the lock in a unlocking state.

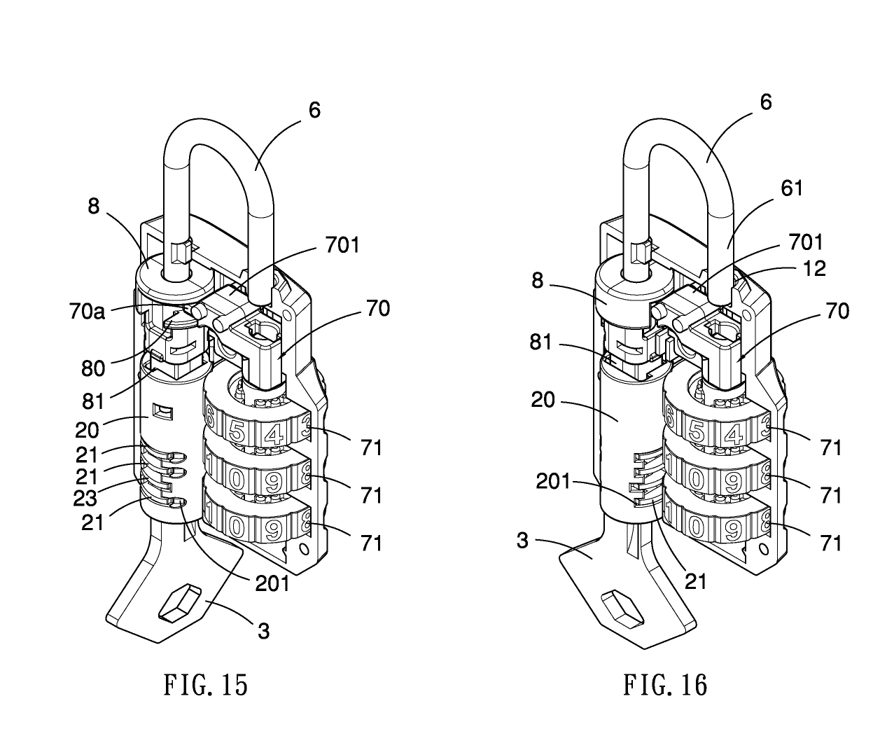

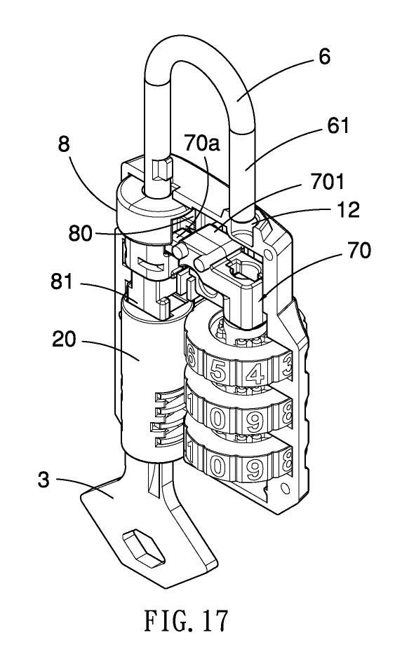

FIGS. 15 and 16 show that the correct combination on the numeral wheels 71 is not entered so that the movable part 70 is locked. At this time, the movable part 70 is not allowed to move axially. In FIG. 15, the aforementioned key 3 has been inserted into the keyhole 200 of the spindle 20 to have the latch plates 21 disposed on the spindle 20 retract into latch slots 201 and away from the room 100 of the housing 1 respectively. As stated above, the spindle 20 is allowed to be rotated by the key 3 so as to drive the controlling unit 8 to rotate. FIG. 16 illustrates that the controlling unit 8 has been rotated to a specific position where the block 80 bars the end 80a of the movable part 70 no more so that the shackle 6 is allowed to be pulled away from the housing 1. Since the block 80 doesn't obstruct the end 80a of the movable part 70, only the controlling unit 8 moves axially with the shackle 6 simultaneously and the free section 61 of the shackle 6 is removed away from the locking hole 12 of the housing 1 so as to have the lock in a unlocking state, as shown in FIG. 17.

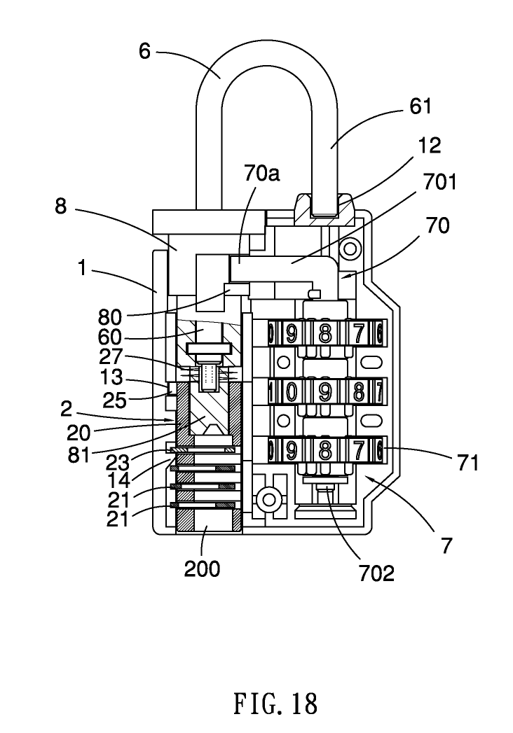

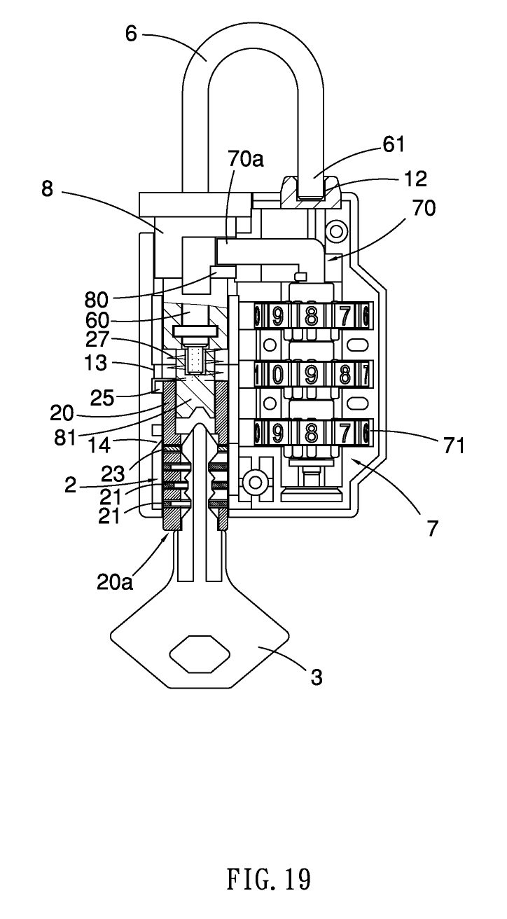

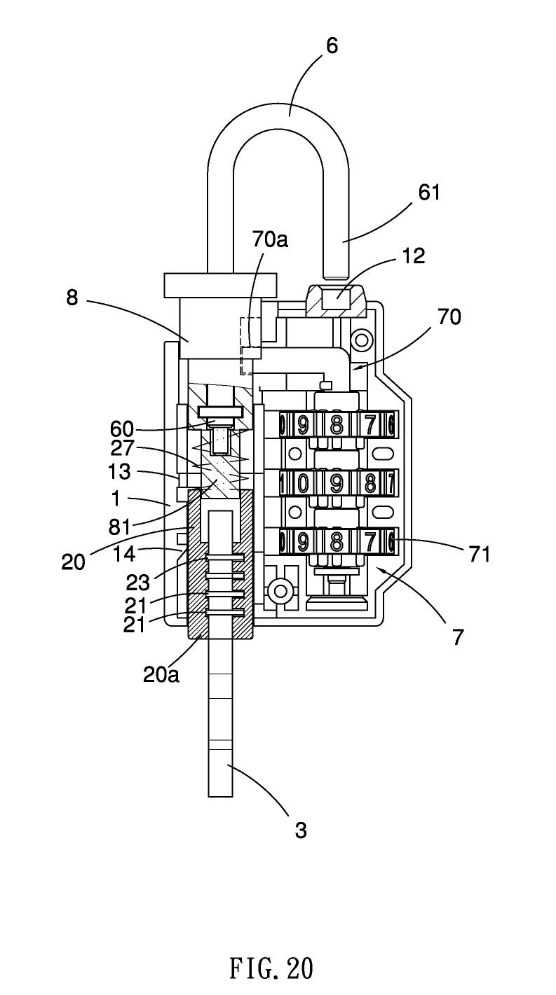

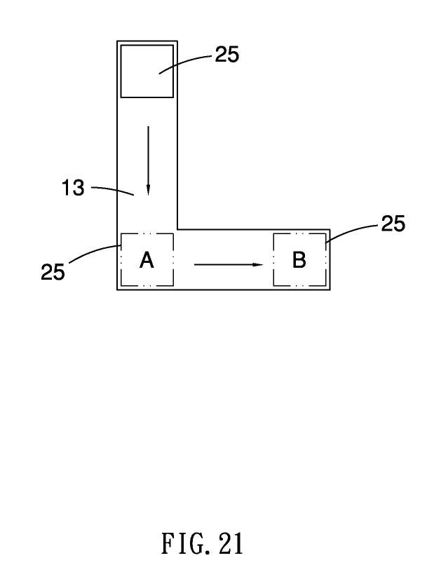

FIGS. 18, 19 and 20 illustrated a padlock in accordance with a second embodiment of the present invention. The second embodiment is generally similar to the first embodiment with same references designated for the same features, except that once the key 3 is inserted into the keyhole 200 of the spindle 20, the blocking plate 23 moves away from a flange 14 of the housing 1a to have the spindle 20 be bounced out of the housing 1a by a spring 27, as shown in FIG. 19. At this time, as shown in FIG. 21, a protrusion 25 of the spindle 20 moves along a channel 130 of the housing 1a to a position A. Then, the key 3 can be rotated to a specific position to allow the shackle 6 being pulled so as to unlock the lock, as shown in FIG. 20. At this time, the protrusion 25 moves along the channel 130 to a position B shown in FIG. 21. If restoration is needed, a user may simply push the spindle 20 back into the housing 1a to its original position.

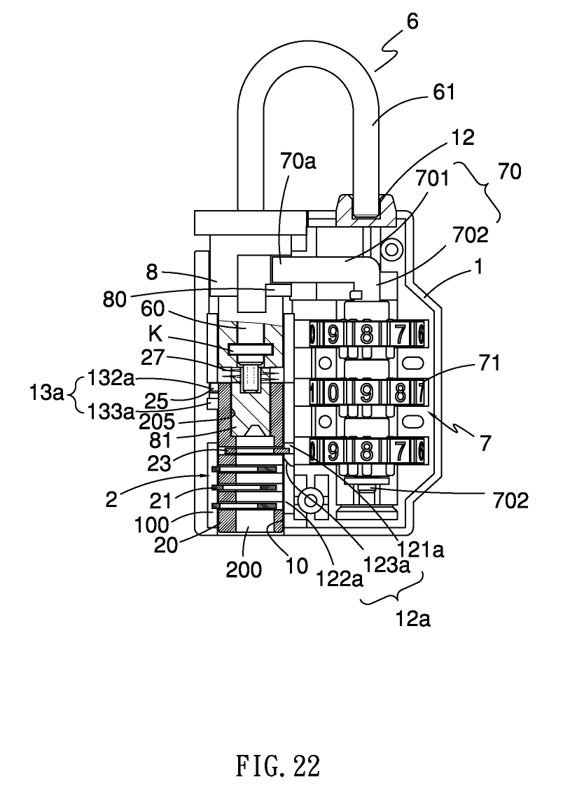

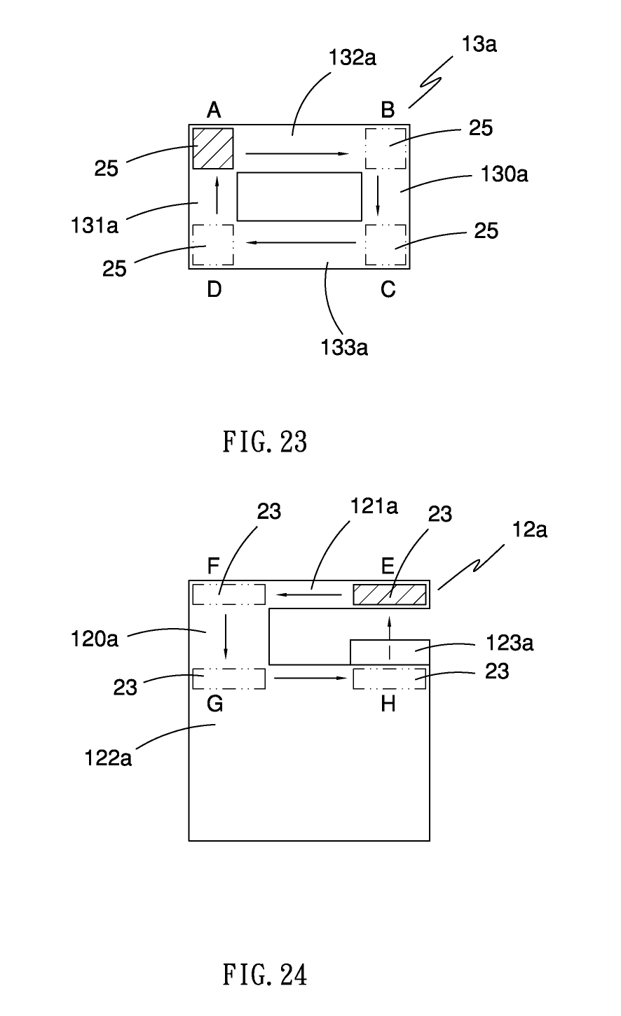

FIGS. 22 to 24 illustrated a padlock in accordance with a third embodiment of the present invention. The third embodiment is generally similar to the foregoing embodiments, except that the blocking slot 12a of the third embodiment has a vertical section 120a, a first horizontal section 121a and a second horizontal section 122a. The first horizontal section 121a extends from an upper portion of the vertical section 120a. The second horizontal section 122a extends from a lower portion of the vertical section 120a and lies under the first horizontal section 121a. A guiding slope 123 is defined at a top edge wall of the second horizontal section 122a for guiding the blocking plate 22 to the first horizontal section 121a. When the key 29 is inserted into the keyhole 200 of the spindle 20, the latch plates 21 are retracted from the latch slot 11; however, the blocking plate 22 doesn't retracted from the blocking slot 12a. The limit slot 13a has a first vertical section 130a, a second vertical section 131a, a first horizontal section 132a and a second horizontal section 133a. The first horizontal section 130a connects an upper portion of the first vertical section 130a and an upper portion of the second vertical section 131a. The second horizontal section 133a connects a lower portion of the first vertical section 130a and a lower portion of the second vertical section 131a.

FIG. 22 illustrates that the shackle 3 is locked, the correct combination of the combination lock core 40 is not entered, and the spindle 20 of the key-operated lock core 2 is not inserted by a mating key. The root section 30 of the shackle 30 moves with the block 23 to a locking position. The latch plates 21 of the key-operated lock core 2 are partly received in the latch slot 11. The blocking plate 22 of the key-operated lock core 2 is partly received in the first horizontal section 121a of the blocking slot 12a. At this time, the spindle 20 is placed in a first indicative position. The spring 24 is biased between the spindle 20 and the block 23. A limit member 25 of the spindle 20 is located in the upper portion of the second vertical section 131a of the limit slot 13a. The lateral stem 42 which extends from the upright stem 41 is received in a horizontal section 281 of the recess 28.

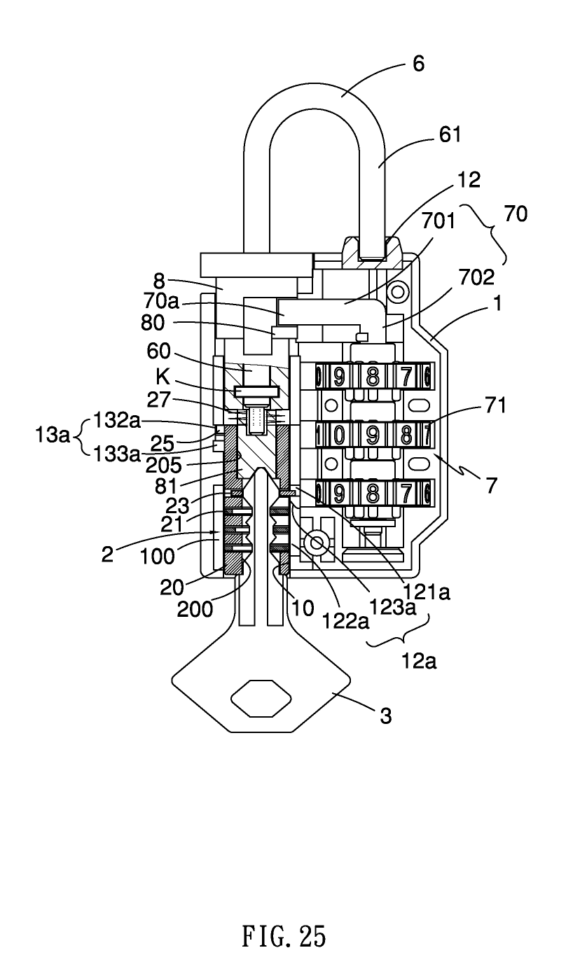

FIG. 25 illustrates that the correct combination of the combination lock core 40 is not entered, and the mating key 29 is inserted into the keyhole 200 of the spindle 20 of the key-operated lock core 2. The combination lock core 40 does not allow the upright stem 41 to move axially, and the lateral stem 42 is received in the horizontal section 281 of the recess 28. Ends of the latch plates 21 are removed from the latch slot 11. An end of the blocking plate 22 of the key-operated lock core 2 remains lodged in the first horizontal section 121a of the blocking slot 12a. The limit member 25 of the spindle 20 is located in the upper portion of the second vertical section 131a of the limit slot 13a. At this time, the spindle 20 is allowed to be rotated by the key 29.

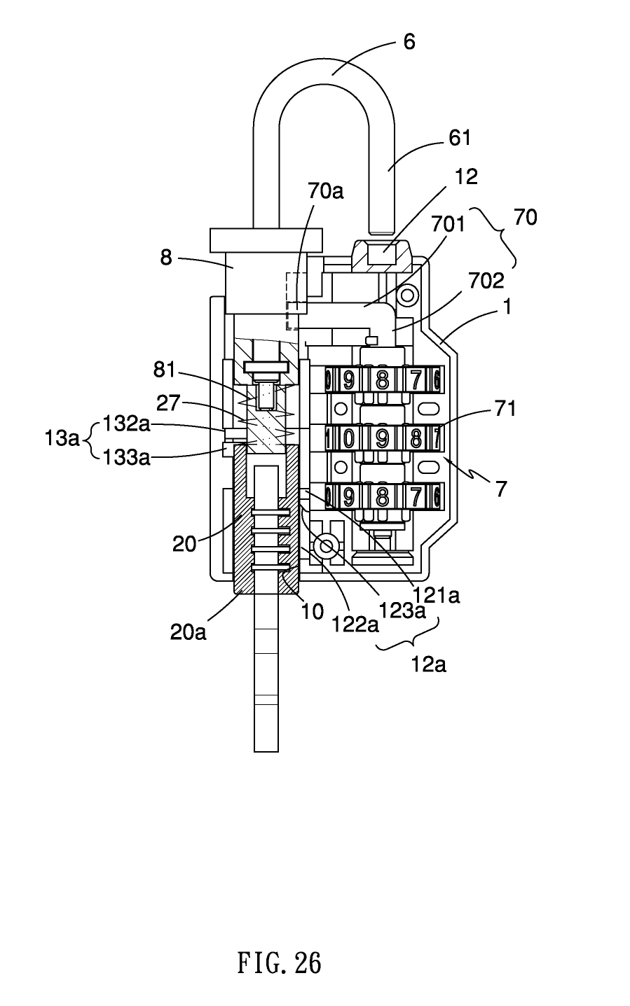

FIG. 26 illustrates that when the key 29 is inserted into the spindle 20 and drives the spindle 20 to rotate clockwise, the limit member 25 of the spindle 20 moves from the upper portion of the second vertical section 131a of the limit slot 13a to the upper portion of the first vertical section 130a so as to rotate the spindle by 90 degrees. The blocking plate 22 moves from an end of the first horizontal section 121a of the blocking slot 12a to the upper portion of the vertical section 120a. And a sliding passage 26 of the spindle 20 incorporates with a sliding portion 27 to drive the block 23 to rotate by 90 degrees so that an end of the lateral stem 42 moves from an end of the horizontal section 281 of the recess 28 to the upper portion of the vertical section 280. At this time, the spindle 20 is bounced down and out by the spring 24, and the limit member 25 of the spindle 20 moves from the upper portion of the first vertical section 130a of the limit slot 13a to the lower portion. The blocking plate 22 moves from the upper portion of the vertical section 120a of the blocking slot 12a to the lower portion so as to move the spindle 20 from the first indicative position to the second indicative position. In the meantime, the block 23 is bounced up and out by the spring 24, and the lateral stem 42 is now in the lower portion of the vertical section 280 of the recess 28 instead of the upper portion. As such, the root section 30 moves with the block 23 from the locking position to the unlocking position so as to release the shackle 3.

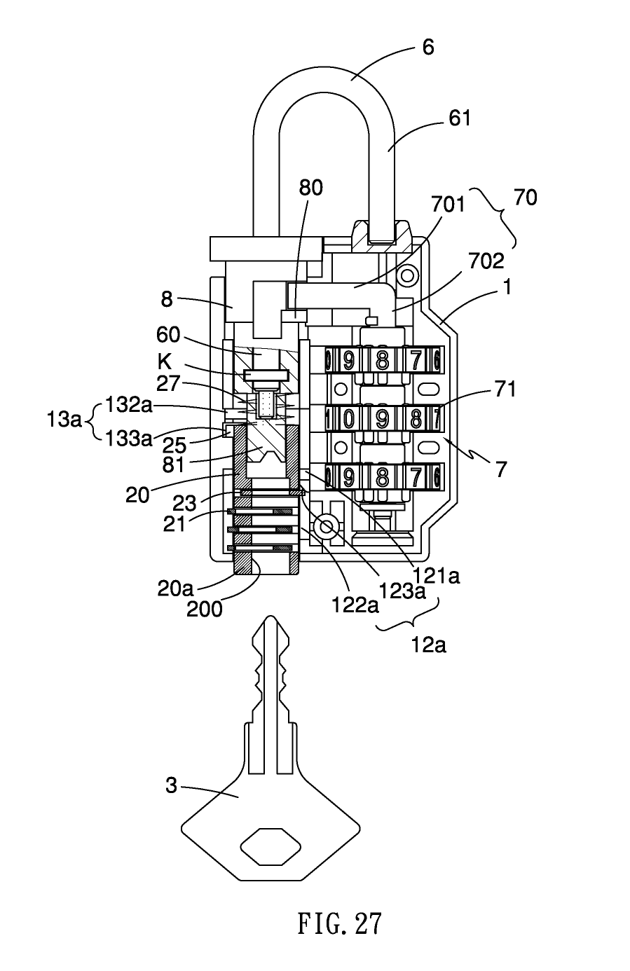

FIG. 27 illustrates that when the root section 30 moves from the locking position to the unlocking position, the spindle 20 is allowed to be rotated back to its original position by the key 29. Thus the limit member 25 of the spindle 20 moves from the lower portion of the first vertical section 130a of the limit slot 13a to the lower portion of the second vertical section 131a via the second horizontal section 133a. The blocking plate 22 moves from the lower portion of the vertical section 120a of the blocking slot 12 to the end of the second horizontal section 122a thereof. And the sliding passage 26 of the spindle 20 incorporates with the sliding portion 27 to drive the block 23 to rotate so that the end of the lateral stem 42 moves from the upper portion of the vertical section 280 of the recess 28 to the end of the horizontal section 281. At this time, the key 29 can be drawn out of the keyhole 200 of the spindle 20 to have the latch plates 21 partly received in the latch slot 11. After that, the spindle 20 may be pushed to move from the second indicative position to the first indicative position so as to move the blocking plate 22 along the guiding slope 123a freely within the spindle 20 until the blocking plate 22 is lodged in the first horizontal section 121a of the blocking slot 12a, and thereby the spindle 20 is locked in the first indicative position.

Accordingly, according to the second embodiment, when the key 29 is inserted into the keyhole 200 of the spindle 20 and is operated to rotate the spindle 20 by 90 degrees, the spindle 20 is bounced out to the second indicative position. Thus, the lower portion of the shackle 20 which is exposed and situated outside the housing 1 indicates to a user that keyhole 200 of the spindle 20 has been inserted and activated by the mating key 29.

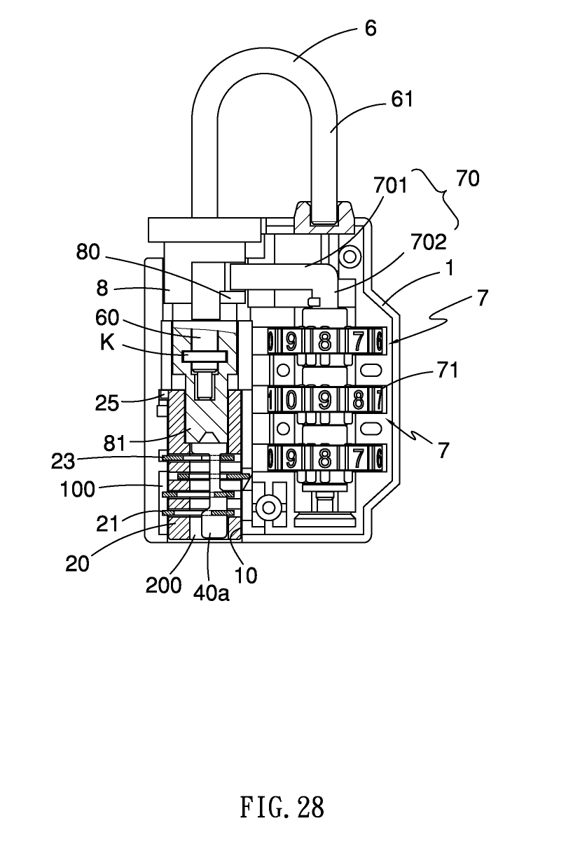

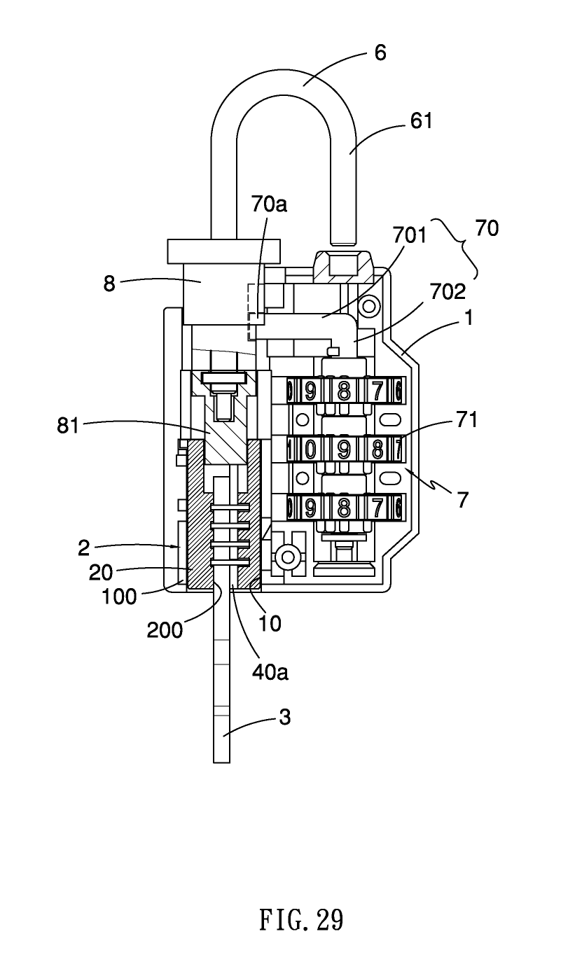

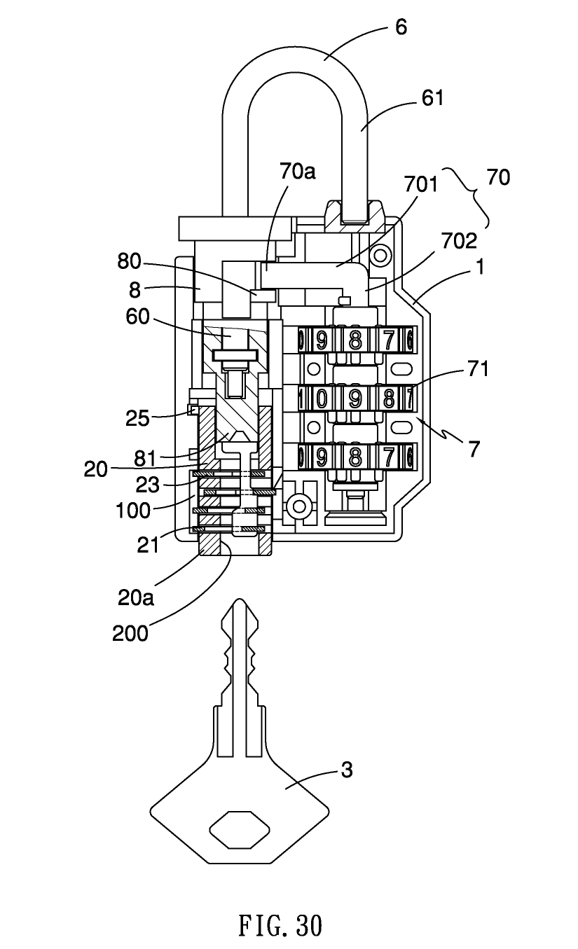

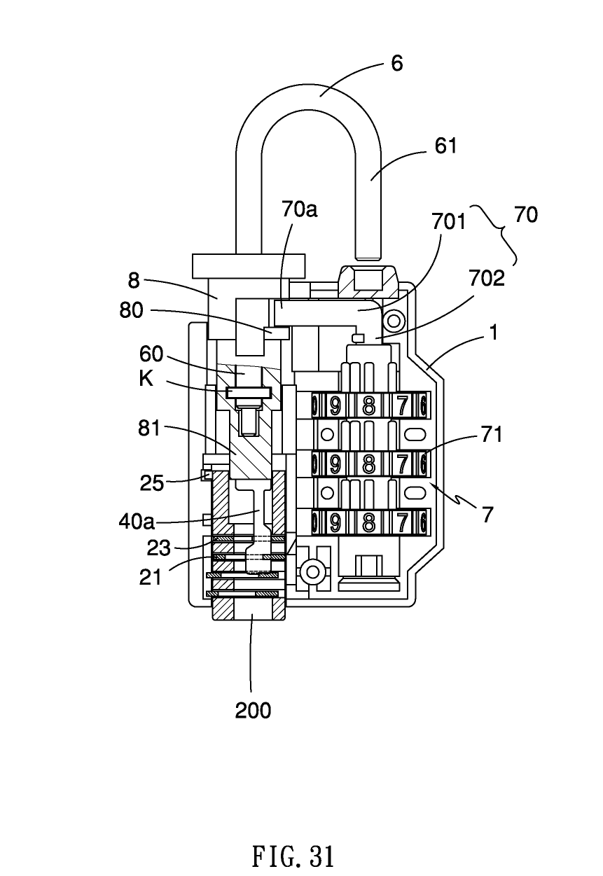

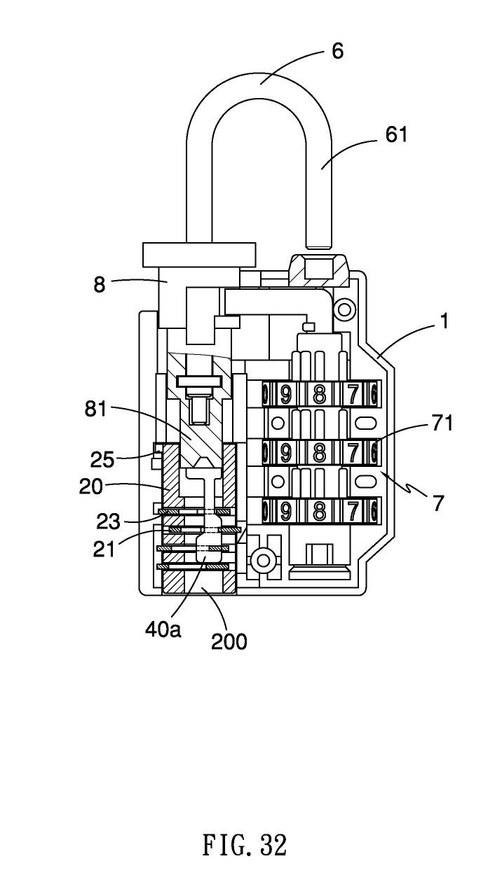

FIGS. 28 to 32 illustrated a padlock in accordance with a fourth embodiment of the present invention. The fourth embodiment is generally similar to the first embodiment, except that the restoring device 22b of the fourth embodiment is joined to a lower portion of the sliding portion 27 of the block 23. When the key 29 is inserted into the keyhole 200 and drives the spindle 20 to rotate clockwise by 90 degrees, the shackle 3 is allowed to be pulled out to be in an unlocking state. At this time, the root section 23 moves to the unlocking position and the block 23 drives the restoring device 22b to move upward. After that when the shackle 3 is pushed back to be in a locking state, the spindle 20 is allowed to be rotated back to its original position by the key 29. While the key 29 is drawn out of the spindle 20, the key 29 drives the spindle 20 to move from the first indicative position to the second indicative position and the latch plates 21 and the blocking plate are partly lodged in the latch slot 11. And the positioning plate 21b moves along the guiding slope 17b downward and is pushed by the restoring device 22b to a position where the positioning plate 21b is lodged in the positioning slot 16b so as to lock the spindle 20 in the second indicative position. After that, if the spindle 20 is to be restored, the correct combination of the combination lock core should be set first, and the shackle 3 is then be pulled up to lift up the root section 30 to the unlocking position and has the block 23 drive the restoring device 22b to move upward so that the blocking plate 22 is removed from the latch slot 11 and the positioning plate 21b is removed from the positioning slot 16b. At this time, the shackle 20 is allowed to be moved from the second indicative position to the first indicative position. When the spindle 20 moves to the first indicative position, the shackle 3 should be placed in the locking state in order to have the root section 30 drive the restoring device 22b to its original position via the block 23. And the positioning plate 21b is also driven to have its end lodged in the guiding slot 15b so as to lock the spindle 20 in the first indicative position.

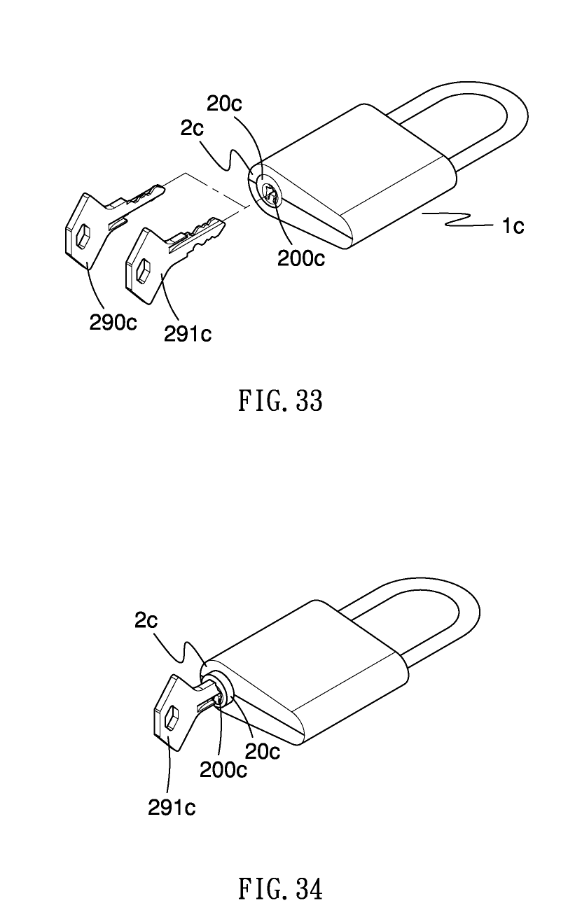

FIGS. 33 to 34 illustrated a padlock in accordance with a fifth embodiment of the present invention. The fifth embodiment simply includes a housing 1c, a key-operated lock core 2c and a shackle 3c as depicted in the foregoing embodiments. The main difference is that the spindle 20c of the key-operated lock core 2c of the present embodiment has a keyhole 200c capable of receiving either a first key 290c or a second key 291c to control whether the shackle 3c is allowed to move in order to unlock the padlock. The second key 291 further controls whether the spindle 20 is allowed to move to the second indicative position.

In the fifth embodiment, the spindle 20c is constructed to move to the second indicative position under one of the three following situations. First of all, the spindle 20c moves to the second indicative position when the key 291c is inserted into the keyhole 200c of the spindle 20c. Second, the spindle 20c moves to the second indicative position when the key 291c is inserted into the keyhole 200c of the spindle 20c and is operated to rotate the spindle 20c to an angle. Third, the spindle 20c moves to the second indicative position when the key 291c is drawn out of the keyhole 200c of the spindle 20c.

In any case, one would understand that the present invention contains industrial applicability in view of the teachings of the foregoing description. Further, the present invention contains novelty because no prior art has been found to be the same with the present invention. Still further, the present invention contains non-obviousness because no prior art has been found to be similar to the present invention. Accordingly, the present invention fulfills the requirements for a utility patent and is filed herein for application.

1. A lock comprising an indicative lock core, said indicative lock core including a spindle; said spindle defining a keyhole to receive a key and being capable of moving to an indicative position in response to operation of said key and remaining in said indicative position to indicate that said indicative lock core has been operated by said key.

2. The lock of claim 1 comprising a housing, said housing defining an opening; said spindle exposed in said opening, wherein when said spindle remains in said indicative position, said spindle is partly situated outside said opening of said housing.

3. The lock of claim 2 comprising a combination lock core; and said combination lock core disposed in said housing and configured to be independent of said indicative lock core to lock or unlock said lock.

4. The lock of claim 3 comprising a shackle, said shackle having a root section and a free section; said root section movably disposed in said housing; said free section connected with said root section and disposed outside said housing, wherein said combination lock core controls movement of said shackle independently and said indicative lock core controls movement of said shackle independently.

5. The lock of claim 4 wherein said combination lock core controls axial movement of said shackle independently and said indicative lock core controls axial movement of said shackle independently.

6. The lock of claim 5 wherein said combination lock core includes a plurality of numeral wheels and a movable part; said numeral wheels is capable of controlling axial movement of said movable part; and the lock further includes a controlling unit connected with said root section of said shackle and being capable of moving axially with said shackle and rotating about said root section of said shackle;
wherein said spindle of said indicative lock core connects with said controlling unit and is able to drive the controlling unit to rotate; said controlling unit has a block and is rotatable between a first position where said block is obstructed by an end of said movable part and a second position where said block departs from said end of said movable part.

7. The lock of claim 1 wherein said indicative lock core includes a plurality of latch plates and a plurality of springs, said spindle defines a plurality of latch slots parallel to one another; said latch slots are vertically interconnected with said keyhole; said latch plates together with the corresponding springs are received in said latch slots respectively; said springs are biased by said latch plates such that said latch plates are normally partly situated outside said latch slots; each latch plate defines a hole in alignment/communication with said keyhole; and said latch plates have inner plateaus in said holes with different height levels, some higher, some lower.

8. The lock of claim 7 wherein said indicative lock core includes a blocking plate; said spindle defines a blocking slot; said blocking plate is movably received in said blocking slot; said blocking slot is parallel with said latch slots and is vertically interconnected with said keyhole; said blocking plate defines a hole in alignment/communication with said keyhole.
